(19) United States
(12) Patent Application Publication
(10) Pub. No.: US 2021/0314546 A1
(43) Pub. Date: Oct. 7, 2021

(54) APPARATUS, METHOD AND SYSTEM FOR GENERATING THREE-DIMENSIONAL IMAGE USING A CODED PHASE MASK

(71) Applicant: Electronics and Telecommunications Research Institute, Daejeon (KR)

(72) Inventors: Ki Hong CHOI, Daejeon (KR); Joong Ki PARK, Daejeon (KR); Kee Hoon HONG, Daejeon (KR)

(73) Assignee: Electronics and Telecommunications Research Institute, Daejeon (KR)

(21) Appl. No.: 17/221,590

(22) Filed: Apr. 2, 2021

(30) Foreign Application Priority Data
Apr. 3, 2020 (KR) 10-2020-0040893
Mar. 22, 2021 (KR) 10-2021-0036548

(51) Int. Cl. H04N 13/214; H04N 13/257; H04N 13/128

(52) U.S. Cl. CPC H04N 13/214; H04N 13/128; H04N 13/257

(57) ABSTRACT

The present disclosure relates to an apparatus, method and system for generating a three-dimensional image using a coded phase mask. According to the present disclosure, an apparatus for generating a three-dimensional image, the apparatus may comprise a communicator for transmitting and receiving a signal and a processor for controlling the communicator, wherein the processor synthesizes complex data for an object based on an image, which is obtained by shooting an object, and generates a three-dimensional image of the object based on the complex data for the object and a point spread function (PSF) image for a point light source.

The present application claims priority to Korean Provisional Applications No. 10-2020-0040893, filed Apr. 3, 2020, and No. 10-2021-0036548, filed Mar. 22, 2021, the entire contents of which are incorporated herein for all purposes by this reference.

### BACKGROUND OF THE INVENTION

### Field of the Invention

The present disclosure relates to an apparatus, method and system for generating a three-dimensional image using a coded phase mask.

### Description of the Related Art

A camera collects light reflected by an object and generates an image expressing the shape and color of the object from the collected light through a recording medium. Generally, a camera collects light reflected by an object by using a lens. Herein, various aberrations occur due to the curvature of a spherical lens. Such optical aberration inhibits a clear image from being generated and thus may be a main factor degrading the performance of a camera. Accordingly, as an additional technology for removing the optical aberration of a leans is needed, an optical system using a lens is configured somewhat complexly.

To solve various optical problems of such a lens-based camera, various technologies of generating images based on a pinhole camera structure have been proposed. FIG. 1 is a view related to a process of generating an image by borrowing a pinhole camera structure. A pinhole camera is an ideal camera free from many optical problems of a lens-based camera and is a device that lets light come through a very small hole (pinhole) and generates an image in a recording medium a certain distance away. However, a pinhole camera has a problem that it has a relatively smaller quantity of light than a lens camera. In order to solve the problem of the pinhole camera, a camera was proposed which borrowed a pinhole camera structure like in FIG. 1 and also used a coded aperture.

A coded aperture is an aperture that has a plurality of pinholes existing at arbitrary positions. Light reflected by an object is collected at each pinhole through a coded aperture and is recorded in a recording medium. When a decoding process is performed based on a plurality of recorded images (patterns), a single image of the object is generated.

### SUMMARY

The present disclosure provides an apparatus, method and system for generating three-dimensional image using a coded phase mask.

According to the present disclosure, an apparatus for generating a three-dimensional image, the apparatus may comprise a communicator for transmitting and receiving a signal and a processor for controlling the communicator, wherein the processor synthesizes complex data for an object based on an image, which is obtained by shooting an object, and generates a three-dimensional image of the object based on the complex data for the object and a point spread function (PSF) image for a point light source.

According to the present disclosure, a method for generating a three-dimensional image, the method may comprise synthesizing complex data for an object based on an image that is obtained by shooting an object and generating a three-dimensional image of the object based on the complex data for the object and a PSF image for a point light source.

According to the present disclosure, A three-dimensional image generation system, the system may comprise a coded phase mask (CPM) for modulating a phase of reflected light of an object, a polarization image sensor that records brightness information of the object as an image based on the reflected light of the object, of which the phase is modulated from the coded phase mask and a three-dimensional image generator that synthesizes complex data for the object based on an image of the object and generates a three-dimensional image of the object based on the complex data for the object and a PSF image for a point light source.

According to the present disclosure, it is possible to effectively generate a precise three-dimensional image.

In addition, it is possible to generate a three-dimensional image by using a coded phase mask at a reduced cost.

### BRIEF DESCRIPTION OF THE DRAWINGS

FIG. 1 is a view related to a process of generating an image based on a coded aperture by borrowing a conventional pinhole camera structure.

FIG. 2 is a view related to a coded aperture correlation holography (COACH) system capable of generating a three-dimensional image applicable to the present disclosure.

FIG. 3 is a view related to a coded phase mask (CPM) used in FIG. 2, brightness information of a pinhole and brightness information of an object that are applicable to the present disclosure.

FIG. 4 is a view related to a monochromatic polarization image sensor applicable to the present disclosure.

FIG. 5 is a view related to a color polarization image sensor applicable to the present disclosure.

FIG. 6 is a view related to a process of obtaining complex data by using a color polarization image sensor applicable to the present disclosure.

FIG. 7 is a view related to a scanning-type system of fabricating a geometric phase element applicable to the present disclosure.

FIG. 8 is a view related to a geometric phase element applicable to the present disclosure.

FIG. 9 is a view related to a three-dimensional image generation system using a coded phase mask according to an embodiment of the present disclosure.

FIG. 10 is a view related to a data processing process of a three-dimensional image generation system using a coded phase mask according to an embodiment of the present disclosure.

FIG. 11 is a view related to a method for generating a three-dimensional image using a coded phase mask according to an embodiment of the present disclosure.

FIG. 12 is a view related to an apparatus for generating a three-dimensional image using a coded phase mask according to an embodiment of the present disclosure.

### DETAILED DESCRIPTION

Hereinafter, embodiments of the present disclosure will be described in detail with reference to the accompanying drawings, which will be easily implemented by those skilled in the art. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. In addition, parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present invention. Also, embodiments that include other components in addition to the components described in the various embodiments are also included in the scope of the present disclosure.

Meanwhile, in the present disclosure, a three-dimensional image may include a complex hologram.

Meanwhile, in the present disclosure, the terms “image generation”, “imaging”, and “image reconstruction” may be used interchangeably.

Meanwhile, in the present disclosure, the terms “point light source” and “pinhole” may be used interchangeably.

Meanwhile, in the present disclosure, the terms “complex hologram”, “complex hologram data”, and “complex data” may be used interchangeably.

Hereinafter, various embodiments of the present disclosure will be described with reference to the accompanying drawings.

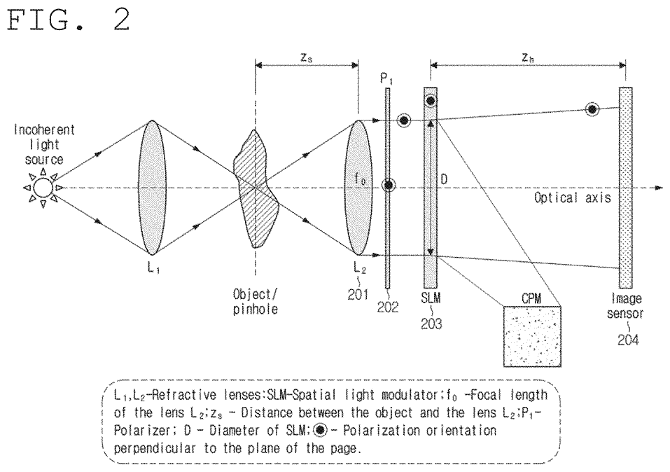

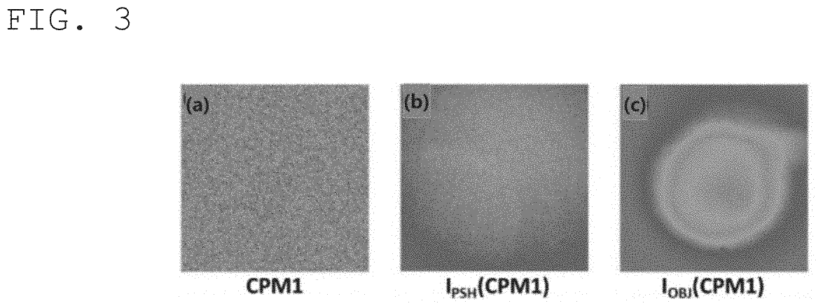

FIG. 2 is a view related to a coded aperture correlation holography (COACH) system capable of generating a three-dimensional image applicable to the present disclosure, and FIG. 3 is a view related to a coded phase mask (CPM) used in a spatial light modulator of the system of FIG. 2, brightness information of a point light source and brightness information of an object that are applicable to the present.

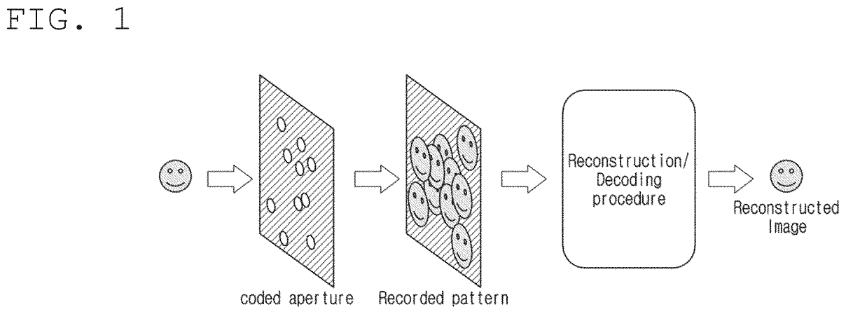

More specifically, FIG. 2 proposes a system that introduces the principle of FIG. 1 to computational photography and generates a three-dimensional digital image by recognizing a defocus pattern through a coded aperture. In addition, (a) of FIG. 3 is one example of a coded phase mask, (b) of FIG. 3 is a view related to brightness information of a point light source according to the coded phase mask of (a), and (c) of FIG. 3 is a view related to brightness information of an object according to the coded phase mask of (a).

FIG. 2 is a view related to a system called COACH that generates a three-dimensional image (i.e., hologram) by using a binary coded mask, which is used mainly in computational photography, as a random phase mask in a phase-only spatial light modulator (SLM).

Unlike a coded aperture camera using a coded aperture of the conventional computational photography that demands a high-load iterative algorithm for reconstructing a three-dimensional image, the system of FIG. 2 uses a point spread function (PSF) library of initial point light sources and may include an object lens (L2) 201, a polarizer (P1) 202, a spatial light modulator (SLM) 203, and an image sensor 204. Herein, the spatial light modulator may be a phase-only spatial light modulator.

When external light is collected through the object lens 201, light is input into the spatial light modulator 203 through the polarizer 202 that filters a light component of a particular polarity.

Next, an image including brightness information on a point light source may be obtained from the image sensor 204 by displaying a coded phase mask (CPM), which shows various phase angles from 0 to 360 degrees, on the spatial light modulator 203. Herein, the coded phase mask may be as shown in (a) of FIG. 3, and the image obtained from the image sensor may be as shown in (b) of FIG. 3. Also, a point light source may be moved in a depth direction on an optical axis, and an image including brightness information of a point light source for each position may be generated. That is, as an image including brightness information of a point light source may be generated according to a distance between positions, there may be a plurality of images. It is possible to construct a PSF library for a corresponding point light source by binding such images.

When a PSF library is constructed, an object may be put in a space to which a point light source has been moved, and an image recording brightness information of the object for a corresponding point like (c) of FIG. 3 may be generated by displaying the coded phase mask used above on a spatial light modulator. Herein, in order to remove a noise component nonuniform distribution of brightness of a point light source, three pieces of brightness information may be used which are generated from an image sensor using three different coded phase masks. In addition, a phase angle distribution of a coded phase mask may be determined basically in the form of a random function. Three sheets of images recording brightness information for an object may be combined into one sheet of complex data. A single sheet of complex data is generated by the following equation.

$$H ( \overline{{r}_{0}} ; {z}_{s} ) = {\sum }_{k = 1}^{K} {I}_{k} ( \overline{{r}_{0}} ; {z}_{s} ) exp ( i {θ}_{k} )$$

Here, Iₖ(r̅₀;zₛ) is brightness information corresponding to the vector r̅₀ and depth value zₛ of each pixel position, which is obtained by k-th exposure (shot).

A sheet of complex data for an object may generate a three-dimensional image of the object by being convolution-operated with a PSF image (e.g., (b) of FIG. 3) in which bright information of a point light source corresponding to a specific position of a previously constructed PSF library is recorded.

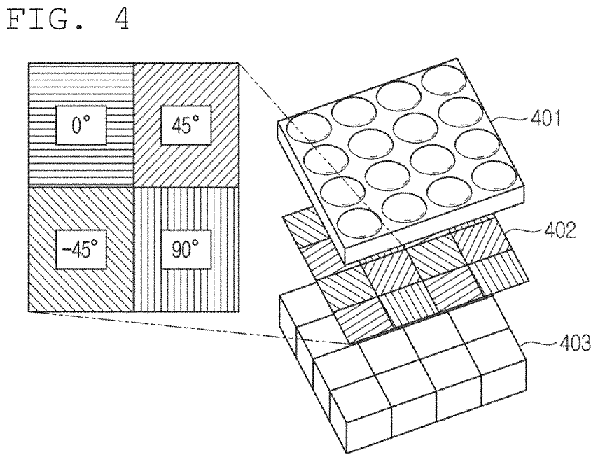

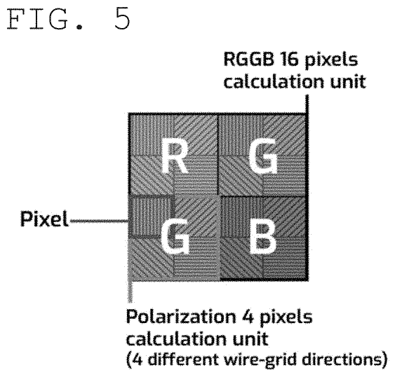

Meanwhile, the image sensor may be a monochromatic polarization image sensor of FIG. 4 or a color polarization image sensor of FIG. 5. This will be described in further detail with reference to FIG. 4 and FIG. 5.

FIG. 4 is a view for explaining a pixel architecture of a monochromatic polarization image sensor applicable to the present disclosure. More specifically, it is a view showing a pixel architecture of an image sensor in which photodiodes 403 are two-dimensionally arranged and to which a microlens array 401 and a polarizer array 402 for obtaining even polarization information are attached.

In one embodiment, the microlens array 401 may be attached on the polarizer array 402. For example, the polarizer array 402 may have 2×2 structure about a pixel and each polarizer is rotated by 0, 45, −45, 90 in degree for adjusting the geometric phase of the light wave as mentioned above. Meanwhile, a degree to which each polarizer rotates corresponds to one embodiment, to which the present disclosure is not limited.

Meanwhile, an image sensor of FIG. 4 is a monochromatic polarization image sensor, and a color polarization image sensor may mean, for example, an image sensor of FIG. 4 with a color filter attached to it. Hereinafter, a color polarization image sensor will be described in further detail with reference to FIG. 5.

FIG. 5 is a view for explaining a pixel array of a polarization image sensor applicable to the present disclosure. More specifically, it is a view for explaining a pixel array of a color polarization image sensor with a color filter attached to it together with a polarizer array.

In one embodiment, in the case of a color polarization image sensor, four polarization components may be expressed by three color channels (e.g., R, G, B) in one shot for an object (e.g., R, G, G, B). Herein, each color channel may be composed of, for example, four pixels, and each pixel may be based on wire-grid directions different from each other. In one embodiment, according to this, a total of four polarization components may be expressed in RGGB.

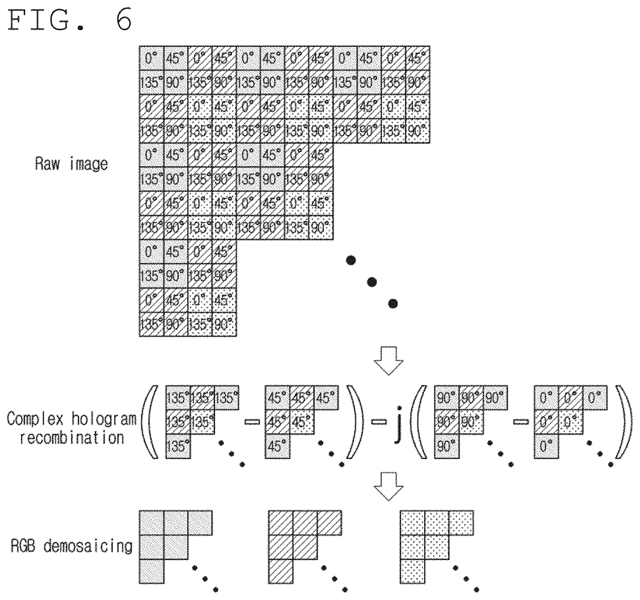

FIG. 6 is a view related to a process of obtaining complex data by using a color polarization image sensor applicable to the present disclosure.

In one embodiment, the color polarization image sensor of FIG. 6 may be the color polarization image sensor of FIG. 5, be a color polarization image sensor that is obtained by attaching a color filter to a monochromatic polarization image sensor including the polarizer array of FIG. 4, and be a sensor that is used in an apparatus, method and apparatus for generating a three-dimensional image using a coded phase mask of the present disclosure.

Brightness information image for an object, which is recorded by a color polarization image sensor, may be a raw image. In one embodiment, a color polarization image sensor may express four polarization components by three colors (e.g., R, G, B). Herein, a polarizer may have phase values that are different from each other. For example, it may have phase values of 0 degree, 45 degrees, 90 degrees, and 135 degrees.

A color polarization image sensor may perform complex hologram recombination by distinguishing polarization components according to phases. Based on this, each component may be collected in each color (demosicing).

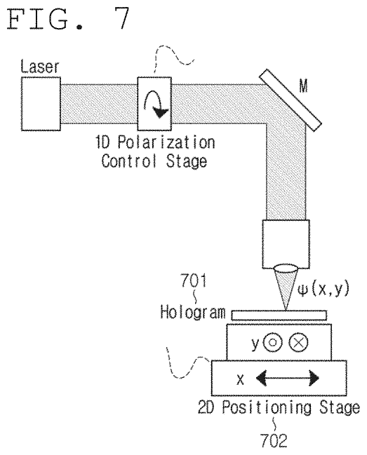

FIG. 7 is a view related to a scanning-type system of fabricating a geometric phase element applicable to the present disclosure. A geometric phase is a phase that is affected by a geometric movement in a parameter space with no change of optical retardation occurring according to an axis to which an optical path or polarization is projected. In optics, it usually means a phase that occurs according to a change of polarization state. It is also called the Panchartnam-Berry (PB) phase. According to a geometric phase element using a liquid crystal that is recently introduced, a phase may be different according to an alignment angle of a liquid crystal. Accordingly, when only a two-dimensional alignment angle information of a liquid crystal is given, a desired phase element may be freely generated. There are various fabrication systems, but one of the systems applicable to the present disclosure is the scanning-type system of FIG. 7. A polarization state of incident light may be defined by an alignment angle that is allocated to a section by moving the section by a 2D positioning system 702 and using a 1D polarization control stage, while a substrate coated with a photoalignment material is put at the position of hologram 701 of FIG. 7. According to this, linear alignment information may be generated on a photoalignment film on a substrate, and then, when a liquid crystal is coated, phase elements with spatially different alignment angles may be generated by self-alignment.

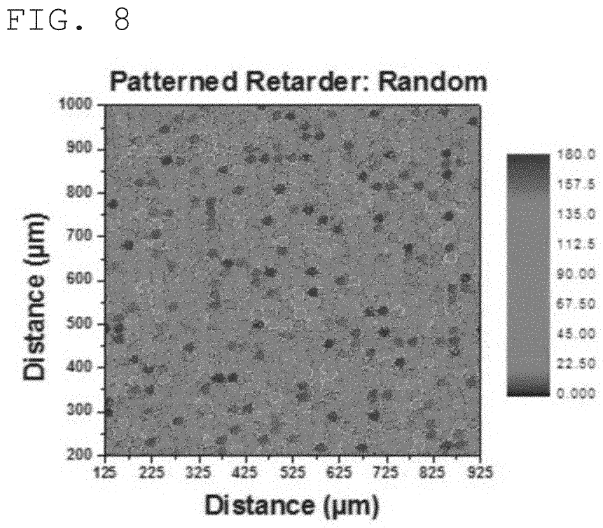

FIG. 8 is a view related to a geometric phase element applicable to the present disclosure.

More specifically, it is a view showing a random phase retarder that may be generated, when a coded phase mask like (a) of FIG. 3 is input, as an input value, into a 1D polarization control stage of a scanning-type system of fabricating a phase element like in FIG. 7. The random phase retarder of FIG. 8 has a random phase value arrangement, and liquid crystals of each section may commonly have a half-wave plate feature when layers of liquid crystals are adjusted. Accordingly, phase modulation may be possible from 0 to 360 degrees due to features of geometric phase. FIG. 8 shows an alignment angle of a liquid crystal in each space based on a coded phase mask or a corresponding phase retardation value by using colors.

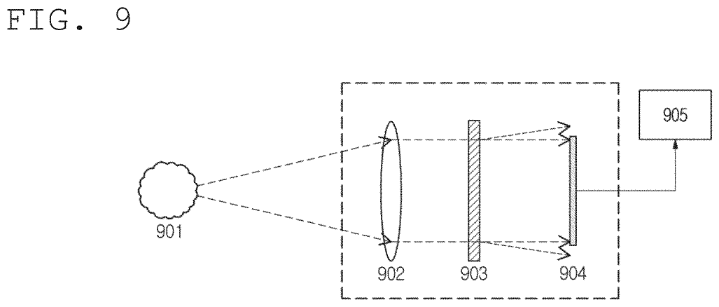

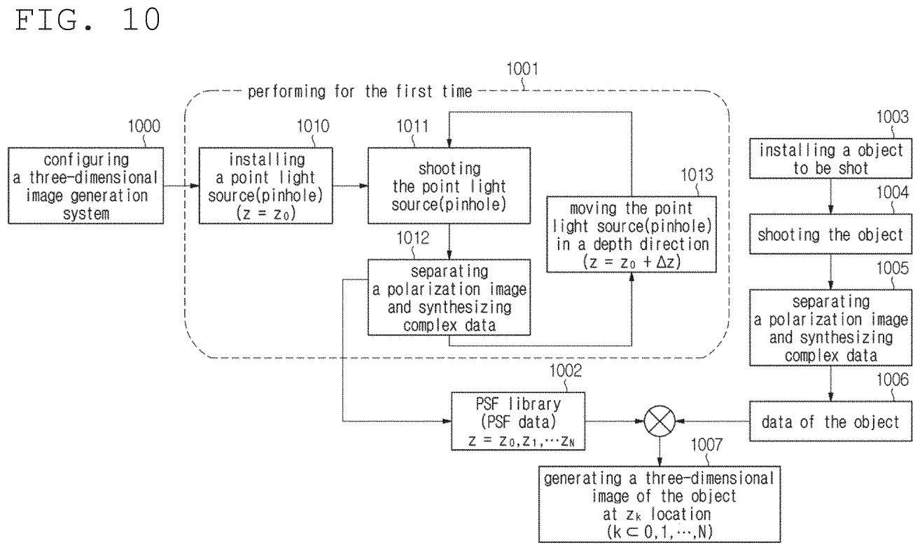

FIG. 9 is a view related to a three-dimensional image generation system using a coded phase mask according to an embodiment of the present disclosure, and FIG. 10 is a view related to a data processing process of a three-dimensional image generation system using a coded phase mask according to an embodiment of the present disclosure.

In one embodiment, a three-dimensional image generation system using a coded phase mask may include an object to be shot 901, an object lens 902, a phase mask 903, a polarization image sensor 904, and a three-dimensional image generator 905.

In one embodiment, when describing the data processing process of FIG. 10, for clarity of description, the description is based on the three-dimensional image generation system of FIG. 9. However, as the three-dimensional image generation system is only one embodiment of the present disclosure, it does not have to be configured as in FIG. 9.

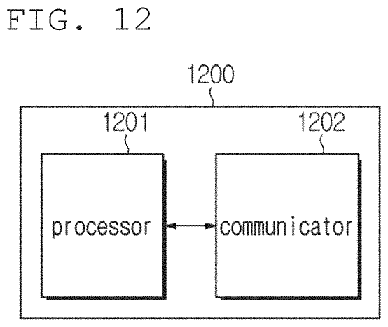

Also, the data processing process of FIG. 10 may be implemented not only by a three-dimensional image generation system but also by a three-dimensional image generator, and the three-dimensional image generator may be like in FIG. 12. However, it is not limited thereto.

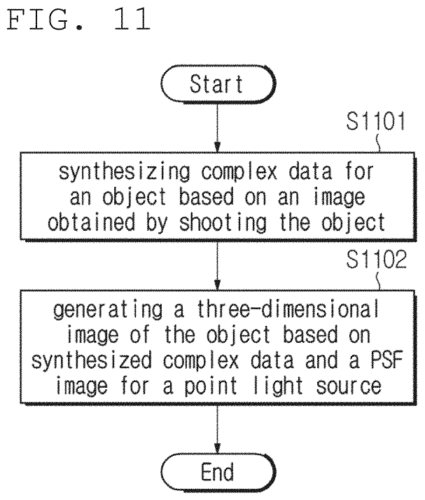

In one embodiment, a three-dimensional image generation system may perform the data processing process of FIG. 10 and/or the image generation method of FIG. 11 and may include the three-dimensional image generator of FIG. 12 as the three-dimensional image generator 905 of this view.

Before generating a three-dimensional image, a three-dimensional generator may perform a process 1001 of obtaining complex data for a point light source, for the first time. First, when a three-dimensional image generation system is configured (1000), a point light source (pinhole) is installed (1010) and is shot (1011), and complex data may be synthesized (1012) by separating a polarization image based on a captured image for the point light source. Separating a polarization image may include a process in which four sheets of images including modulated brightness information are generated based on an image for a point light source, which is obtained by a single shot, through the phase mask 903 of FIG. 9, by using an image sensor 904 of FIG. 9. Meanwhile, this process may be repeated by moving (1013) a point light source (pinhole) at a predetermined interval in a depth direction on an optical axis. For example, a PSF image may be generated while shooting by moving a point light source at an interval of Δz from a depth position z0 to a depth position zN, and a depth range and an interval that are set herein may be a depth acquisition range and depth resolution of a corresponding system. Accordingly, a PSF image may be generated for a point light source that is based on complex data synthesized at each position. Accordingly, there may be a plurality of PSF images for a point light source. Based on PSF images for a plurality of point light sources, a PSF library 1002 may be generated. A PSF library, which corresponds to a response characteristic of a system for each point light source, may be used later to reconstruct a three-dimensional image from complex data of an object.

After the PSF library is built up, an object to be shot is installed (1003) and is shot (1004). When the reflected light of an object is incident on the object lens 902, light information may be collected and may pass through the phase mask (903). At this time, the phase mask 903, which modulates a phase of the reflected light of the object, may be a coded phase mask (CPM) and may include a coded half-wave phase mask. Herein, the coded half-wave phase mask includes what is illustrated in FIG. 8 and may include a geometric phase element that is generated by FIG. 7. The phase mask 903 may randomly modulate phase information of input light.

Next, the polarization image sensor 904 may record brightness information of the object as an image on the basis of the reflected light of the object, of which the phase is modulated by a coded phase mask. Based on an image that is generated when an object is shot (1004), each polarization image may be separated. Based on this, the three-dimensional image generator 905 may synthesize (1005) complex data for the object. More specifically, the polarization image sensor 904 may transform phase information of input light at a position corresponding to each pixel into intrinsic brightness information based on an allocation angle of a polarizer corresponding to the pixel and may record the brightness information in a pixel. Herein, the polarization image sensor 904 may include the monochromatic polarization image sensor of FIG. 4 and/or the color polarization image sensor of FIG. 5. Complex data, which are synthesized by the three-dimensional image generator 905, may be included in object data 1006. When the polarization image sensor 904 is a color polarization image sensor, the synthesized complex data may be generated by performing the complex data transform process of FIG. 6. The three-dimensional image generator 905 may synthesize complex data for an object based on an image of the object and may generate a three-dimensional image of the object based on the complex data for the object and a point spread function (PSF) image for a point light source. When the polarization image sensor 904 is a color polarization image sensor, since brightness information of each color is recorded in a pixel, the three-dimensional image generator 905 may reconstruct a full-color three-dimensional image for an object.

Herein, when an object is shot at a specific depth zk, the three-dimensional image generator 905 may reconstruct (1007) a three-dimensional image of the object based on a PSF image for a point light source shot at a specific depth (e.g., zk), which is included in a PSF library, and synthesized complex data of the object. Herein, a PSF image for a point light source and synthesized complex data of an object may be convolutionally operated. In other words, the convolution of the PSF image for a point light source and the synthesized complex data of the object may be possible.

Meanwhile, the lens 902, the phase mask 903, the polarization image sensor 904, and the three-dimensional image generator 905 were distinguished above for clarity of explanation. The phase mask 903 and the polarization image sensor 904 may be configured as one apparatus, or the phase mask 903 and/or the polarization image sensor 904 may be included in the three-dimensional image generator 905. However, as this is merely one embodiment, the present disclosure is not limited thereto.

FIG. 11 is a view related to a method for generating a three-dimensional image using a coded phase mask according to an embodiment of the present disclosure.

In one embodiment, the method for generating a three-dimensional image in FIG. 11 may be implemented either by the three-dimensional image generation system of FIG. 9 or by a three-dimensional image generator of FIG. 12, but is not limited thereto.

In another embodiment, the method for generating a three-dimensional image in FIG. 11 may be implemented after the step 1001 of the data processing process of FIG. 10 is performed, but is not limited thereto.

In one embodiment, based on an image that is obtained by shooting an object, complex data for the object may be synthesized (S1101). Herein, an image obtained by shooting an object may include, as described above with reference to another drawing, an image including phase modulation brightness information that is modulated through a phase mask after the object is shot. Herein, a phase mask includes a coded phase mask, and a coded phase mask may include a coded half-wave phase mask. Herein, the coded half-wave phase mask may be based on a geometric phase element that is fabricated by a scanning method. In one embodiment, there may be a plurality of images that are obtained by shooting an object. They may be obtained by a single shot using a polarization image sensor and may include phase-modulated brightness information for an object. Also, a polarization image sensor that is used may be the monochromatic polarization image sensor of FIG. 4 or the color polarization image sensor of FIG. 5. When a polarization image sensor that is used is a color polarization image sensor, phase-modulated brightness information for an object may include brightness information of each color. Also, synthesis of complex data for an object may be performed by the above-described process of FIG. 6 for synthesizing complex data but is not limited thereto. Also, synthesizing (S1101) complex data for an object based on an image that is obtained by shooting the object may include a process of separating a polarization image by shooting (1004 of FIG. 10) an object and of synthesizing (1005 of FIG. 10) complex data.

Based on synthesized complex data for an object and a PSF image for a point light source, a three-dimensional image of an object may be generated (S1102). A PSF image for a point light source may be a PSF image that is extracted from a PSF library for a point light source and corresponds to a position of an image obtained by shooting the object. A process of building up a PSF library may be the same as the process that was described with reference to FIG. 9 and FIG. 10 and may correspond to the steps 1001 and 1002 of FIG. 10. More specifically, as mentioned above, a PSF library may include a plurality of PSF images that are obtained by changing a depth of a point light source. A PSF image, which is obtained by changing a depth of a point light source, may be an image that is generated by synthesizing complex data for a point light source based on an image that is obtained by shooting a point light source at each depth. Herein, complex data may be included in the object data of the step S1006 of FIG. 10. In addition, a three-dimensional image of an object may be generated through a convolution operation of a PSF image for a point light source and complex data for an object. This may correspond to the step 1007 of FIG. 10.

Meanwhile, as FIG. 11 is merely one embodiment of the present disclosure, the order of FIG. 11 may be changed, another step may be added, apart from the steps of FIG. 11, or some steps may be excluded.

FIG. 12 is a view related to an apparatus for generating a three-dimensional image using a coded phase mask according to an embodiment of the present disclosure.

In one embodiment, a three-dimensional image generator 1200 using a coded phase mask may include a communicator 1202 for transmitting and receiving a signal and a processor 1201 for controlling the communicator 1202.

In one embodiment, the three-dimensional image generator of FIG. 12 may implement a method of FIG. 11 for generating a three-dimensional image using a coded phase mask and may be included in the system of FIG. 9, but is not limited thereto.

In one embodiment, the processor 1201 may synthesize complex data for an object based on an image, which is obtained by shooting an object, and may generate a three-dimensional image of the object based on the complex data for the object and a point spread function (PSF) image for a point light source. An image obtained by shooting an object may be obtained through a coded phase mask (CPM) by a polarization image sensor. A coded phase mask may be a coded half-wave phase mask, and a coded half-wave phase mask may be based on a geometric phase element that is fabricated by a scanning method. This may include what is described with reference to FIG. 5 and FIG. 6. There may be a plurality of images that are obtained by shooting an object. They may be obtained by a single shot using a polarization image sensor and may include phase-modulated brightness information for an object. Herein, the above-mentioned polarization image sensor may include the polarization image sensors of FIG. 4 and FIG. 5. In the case of a color polarization image sensor, phase-modulated brightness information for an object may include brightness information of each color. A PSF image for a point light source may be a PSF image that is extracted from a PSF library for a point light source and corresponds to a position of an image obtained by shooting an object. A PSF library may include a plurality of PSF images that are obtained by changing a depth of the point light source. A PSF image, which is obtained by changing a depth of a point light source, may be generated by synthesizing complex data for a point light source based on an image that is obtained by shooting the point light source at each depth. A three-dimensional image of an object may be generated through a convolution operation of a PSF image and complex data for an object.

Meanwhile, although not illustrated in FIG. 12, a three-dimensional image generator using a coded phase mask may further include a memory, which includes random access memory (RAM) and read only memory (ROM), a user interface input device, a user interface output device, a storage, a network interface, and a bus.

Also, there may be one or more processors 1201 of FIG. 12, which may be a central processing unit (CPU) or a semiconductor device that processes commands stored in a memory and/or a storage. A memory and a storage may include various types of volatile or non-volatile storage media.

In the existing system, a phase-only spatial light modulator is used to represent a coded phase mask, however, it is an expensive active element that requires a driving circuit and additional power and has a limit to enlarge the diameter of an aperture. However, according to the present disclosure, the system for generating a three-dimensional image is effectively configured by using a coded half-wave phase mask based on a geometric phase element.

In addition, according to the present disclosure, it is possible to obtain four images comprising phase-modulated brightness information by a single shot of an object instead of obtaining images by using coded phase masks of the polarization image sensor in time sequence. Therefore, efficient image obtaining may be possible.

Moreover, according to the present disclosure, a highly compact three-dimensional image generation system having no chromatic dispersion effect due to wavelength dependency of aberration and diffraction caused by a lens may be manufactured as a mass-producible device without additional power.

Accordingly, steps of a method or an algorithm described in relation to embodiments of the present disclosure may be directly implemented by hardware, which is executed by a processor, a software module, or a combination of these two. A software module may reside in a storage medium (that is, a memory and/or a storage) like RAM, flash memory, ROM, EPROM, EEPROM, register, hard disk, removable disk, and CD-ROM. An exemplary storage medium is coupled with a processor, and the processor may read information from a storage medium and may write information into a storage medium. In another method, a storage medium may be integrated with a processor. A processor and a storage medium may reside in an application-specific integrated circuit (ASIC). An ASIC may reside in a user terminal. In another method, a processor and a storage medium may reside in a user terminal as individual components.

In addition, various embodiments of the present disclosure may be implemented by hardware, firmware, software, or a combination thereof. For implementation by hardware, one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), general purpose It may be implemented by a processor (general processor), a controller, a microcontroller, a microprocessor, or the like. For example, it is obvious that it can be implemented in the form of a program stored on a non-transitory computer readable medium that can be used at the end or edge, or a program stored on a non-transitory computer readable medium that can be used at the edge or the cloud. Do. In addition, it can be implemented by a combination of various hardware and software.

Although the exemplary methods of the present disclosure are represented by a series of acts for clarity of explanation, they are not intended to limit the order in which the steps are performed, and if necessary, each step may be performed simultaneously or in a different order. In order to implement a method according to the present disclosure, the illustrative steps may include an additional step or exclude some steps while including the remaining steps. Alternatively, some steps may be excluded while additional steps are included.

The scope of the present disclosure is software or machine-executable instructions (e.g., operating systems, applications, firmware, programs, etc.) that allow an operation according to a method of various embodiments to be executed on a device or a computer, and such software or It includes a non-transitory computer-readable medium which stores instructions and the like and is executable on a device or a computer.

For example, a program for generating a three-dimensional image using a coded mask according to an embodiment of the present disclosure may be a program stored in a non-transitory computer-readable medium, which synthesizes complex data for an object based on an image, which is obtained by shooting an object, and generates a three-dimensional image based on the synthesized complex data and a PSF image for a point light source.

The present disclosure described above is capable of various substitutions, modifications, and changes without departing from the technical spirit of the present disclosure for those of ordinary skill in the technical field to which the present disclosure belongs, so the scope of the present disclosure is described above. It is not limited by one embodiment and the accompanying drawings.

What is claimed is:

1. An apparatus for generating a three-dimensional image, the apparatus comprising:
a communicator for transmitting and receiving a signal; and
a processor for controlling the communicator,
wherein the processor synthesizes complex data for an object based on an image, which is obtained by shooting an object, and generates a three-dimensional image of the object based on the complex data for the object and a point spread function (PSF) image for a point light source.

2. The apparatus of claim 1,
wherein the image obtained by shooting the object is through a coded phase mask (CPM) by a polarization image sensor.

3. The apparatus of claim 2,
wherein the coded phase mask is a coded half-wave phase mask.

4. The apparatus of claim 3,
wherein the coded half-wave phase mask is based on a geometric phase element that is fabricated by a scanning method.

5. The apparatus of claim 2,
wherein a plurality of images is obtained by shooting the object,
wherein the plurality of images is obtained by a single shot through the polarization image sensor, and
wherein the plurality of images comprises phase-modulated brightness information for the object.

6. The apparatus of claim 5,
wherein the polarization image sensor is a color polarization image sensor, and
wherein the phase-modulated brightness information for the object comprises brightness information of each color.

7. The apparatus of claim 1,
wherein the PSF image for the point light source is a PSF image that is extracted from a PSF library for the point light source and corresponds to a position of an image that is obtained by shooting the object.

8. The apparatus of claim 7,
wherein the PSF library comprises a plurality of PSF images that are obtained by changing a depth of the point light source.

9. The apparatus of claim 7,
wherein a PSF image, which is obtained by changing the depth of the point light source, is generated by synthesizing complex data for the point light source based on the image that is obtained by shooting the point light source at each depth.

10. The apparatus of claim 1,
wherein the three-dimensional image of the object is generated through a convolution operation of the PSF image and the complex data for the object.

11. A method for generating a three-dimensional image, the method comprising:
synthesizing complex data for an object based on an image that is obtained by shooting an object; and
generating a three-dimensional image of the object based on the complex data for the object and a PSF image for a point light source.

12. The method of claim 11,
wherein the image, which is obtained by shooting the object, is obtained through a coded phase mask (CPM) by a polarization image sensor, and
wherein the coded phase mask is a coded half-wave phase mask.

13. The apparatus of claim 3,
wherein the coded half-wave phase mask is based on a geometric phase element that is fabricated by a scanning method.

14. The method of claim 11,
wherein a plurality of images is obtained by shooting the object,
wherein the plurality of images is obtained by a single shot through the polarization image sensor, and
wherein the plurality of images comprises phase-modulated brightness information for the object.

15. The method of claim 14,
wherein the polarization image sensor is a color polarization image sensor, and
wherein the phase-modulated brightness information for the object comprises brightness information of each color.

16. The method of claim 11,
wherein the PSF image for the point light source is a PSF image that is extracted from a PSF library for the point light source and corresponds to a position of an image that is obtained by shooting the object.

17. The method of claim 16,
wherein the PSF library comprises a plurality of PSF images that are obtained by changing a depth of the point light source.

18. The method of claim 16,
wherein a PSF image, which is obtained by changing the depth of the point light source, is generated by synthesizing complex data for the point light source based on the image that is obtained by shooting the point light source at each depth.

19. The method of claim 11,
wherein the three-dimensional image of the object is generated through a convolution operation of the PSF image and the complex data for the object.

20. A three-dimensional image generation system, the system comprising:
a coded phase mask (CPM) for modulating a phase of reflected light of an object;
a polarization image sensor that records brightness information of the object as an image based on the reflected light of the object, of which the phase is modulated from the coded phase mask; and
a three-dimensional image generator that synthesizes complex data for the object based on an image of the object and generates a three-dimensional image of the object based on the complex data for the object and a PSF image for a point light source.
